(19) United States
(12) Patent Application Publication
(10) Pub. No.: US 2004/0112122 A1
(43) Pub. Date: Jun. 17, 2004

(54) BS&W metering apparatus & method

(76) Inventor: Kenneth A. Steward, Midland, TX (US)

Correspondence Address: THE LAW OFFICES OF H. DENNIS KELLY, 2401 TURTLE CREEK, DALLAS, TX, 75219, US

(21) Appl. No.: 10/248,075

(22) Filed: Dec. 16, 2002

(51) Int. Cl. G01N 9/36

(52) U.S. Cl. 73/61.71; 73/61.44

(57) ABSTRACT

An apparatus and method for automatically measuring BS&W of a hydrocarbon stream uses a Coriolis meter or densitometer to measure raw stream density, followed by separation of water and sediment from the hydrocarbon by at least one cyclonic separator, followed by measuring the density of the stream after separation. A BS&W calculator/controller processes the density measurements and produces a percentage BS&W signal. Preferably, a temperature sensor measures the temperature of the stream before or after separation and the temperature measurement is used to back-calculate volumetric flow rate.

### TECHNICAL FIELD

This invention relates in general to process instrumentation. In particular, the invention relates to an apparatus and method for automatically measuring the Basic Sediment and Water (BS&W) content of a liquid hydrocarbon stream and outputting a measurement signal for use by other process instrumentation or for indicating/recording purposes.

### DESCRIPTION OF THE RELATED ART

The more common type of contaminant monitor uses a capacitance sensor to detect the amount of water in the hydrocarbon stream. The dielectric constant of water is about 80, while dielectric constants for typical liquid hydrocarbons are between 2 and 3. Changes in water content therefore cause a significant change in the stream's total dielectric constant. However, since the hydrocarbon typically makes up over ninety-eight percent of the stream's total mass, changes in the hydrocarbon makeup of the stream can also have significant effects on total dielectric constant.

A standard field method for “Determination of Sediment and Water in Crude Oil by the Centrifuge Method” is described in ASTM Test Method D96, and is duplicated in Chapter 10.4 of the API Standards. However, the method is designed for batch determination of BS&W, and requires manual reading of sediment level in a tapered centrifuge tube. A method that can be used for continuous monitoring of fluid flow in a line would be especially desirable for performing custody transfer proving and guarantee test runs.

A need remains for an apparatus and method for on-site BS&W measurement of hydrocarbon streams that is accurate over the typical range of changes in temperature, pressure and composition for such streams. Such an apparatus and method should also provide a BS&W signal that can be used by an existing logging station or control system. An apparatus that is inexpensive to build and simple and reliable to operate is also desired.

### SUMMARY OF INVENTION

In general, an apparatus that achieves the desired features and advantages includes means for measuring density of a raw stream, means for separating water and sediment from the raw stream, means for measuring the density of the post-separation stream, and means for calculating percentage BS&W and generating a signal representing the calculated BS&W value. The means for measuring density of the raw stream is preferably a Coriolis meter, because a Coriolis meter can simultaneously measure the mass flow of the stream. Separated sediment and water are blended back into the post-separation stream downstream of the density measurement. An optional backpressure valve or equivalent device provides means for preventing flashing. An optional temperature transducer measures the temperature of the raw stream and creates a temperature signal that is used by the means for calculating BS&W to inferentially calculate a volumetric flow rate from the mass flow rate measured by the Coriolis meter.

The method of the invention includes the steps of measuring the density of the raw stream, separating sediment and water from the raw stream to form a ‘clean’ stream, measuring the density of the clean stream, and calculating the percent BS&W from the density readings. When a Coriolis meter is used to measure the raw stream and the temperature of the raw stream is measured, additional calculations can be performed to determine the total volumetric flow of the raw stream.

In another apparatus embodiment of the invention, a sampling container is used to collect samples of feed during a custody transfer period, the sample size being proportional to the feed flow rate at the sampling time. After custody transfer is completed, the collected sample material is circulated without removing sediment and water, and the density is measured. The circulation flow is then redirected to separate sediment and water from the stream prior to measuring the density of the remaining stream. The measurements are used to calculate percentage BS&W of the total sample material. Preferably, the separated sediment/water stream is mixed back into the clean stream following the density measurement.

The apparatus of the invention has several advantages over the prior art. First, in most of the embodiments the apparatus can provide a continuous measurement of percentage BS&W for a stream, as well as the total mass and volumetric flow rate of the stream when Coriolis meters are used. The apparatus can give a more accurate reading of BS&W than prior art devices, especially for substantial changes in stream composition and temperature. The apparatus and method do not require disposal of separated basic sediment and water. The equipment can be assembled on a mobile platform to allow using the same apparatus at numerous locations in an oil field or pumping station to amortize the apparatus construction cost. The equipment is rugged and can be operated automatically. Minimal training is required to operate the apparatus and perform the method of the invention.

Additional features and advantages of the invention will become apparent in the following detailed description and in the drawings.

### BRIEF DESCRIPTION OF DRAWINGS

FIG. 1 is a schematic piping diagram of an apparatus of the invention designed for use in measuring the entire flow of a stream.

FIG. 2 is a schematic piping diagram of an alternative apparatus embodiment for use in measuring a scaled portion of a stream.

FIG. 3 is a schematic piping diagram for a closed sampling system embodiment.

FIG. 4 is a partially cutaway left plan view of a typical apparatus mounted on a trailer for use at more than one location.

### DETAILED DESCRIPTION

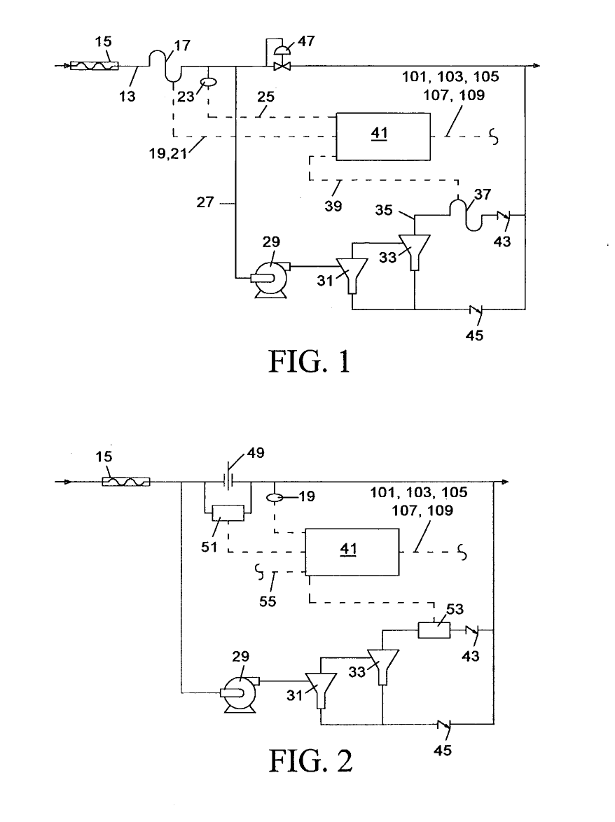

FIG. 1 shows a preferred apparatus 11 of the invention for use in crude oil transport unloading, where transported crude oil is delivered to an unloading location and delivered through a custody transfer metering facility such as a LACT (Lease Automatic Custody Transfer) unit. The apparatus is also useful in other applications, such as determining net oil from a well for well testing and oil royalty allocation. In these applications, the metering system handles the entire product flow, and external volumetric flow measurement is not required for operation. A raw stream 13 of crude oil passes through an optional static mixer 15 to develop a desirable flow profile before the stream goes to a raw stream density meter 17. Flow straighteners or other devices known in the art can be used in placed of the static mixer 15. When flow straighteners or other devices are not used, care should be taken to arrange piping upstream of flow metering sensors to ensure a good flow profile for accurate and repeatable flow and density measurements.

A Coriolis meter is used as the raw stream density meter 17 so that the mass flow rate of the raw stream can be measured simultaneously. The Coriolis meter is also preferred because the mass flow rate measurement is substantially independent of stream temperature, pressure and composition. Signals 19 and 21 corresponding respectively to raw stream density and raw stream mass flow rate are transmitted from the electronics in the Coriolis meter to a BS&W calculator/controller 41 that will be discussed later.

A conventional temperature sensor 23 measures the temperature of the raw stream and transmits a temperature signal 25 to the BS&W calculator/controller 41. This signal is used for back-calculating volumetric flow from the mass flow rate signal 21.

A slip stream 27 taken off the raw stream 13 goes to a pump 29 and then through two cascaded cyclonic separators 31 and 33 to remove water and sediment from the stream, leaving a ‘clean’ stream 35 that is sent to clean stream density meter 37. In some cases, the pump 29 can be omitted. The clean stream density meter 37 measures the density of the clean stream 35 and transmits a clean stream density signal 39 to the BS&W calculator/controller 41. A densitometer can be used for the clean stream density meter 37 without any loss of functionality, since the flow rate of the clean stream is not required for any calculations. Check valves 43 and 45 are usually required to prevent contaminating the clean stream 35 with separated BS&W.

The BS&W calculator/controller 41 takes the various input signals 19, 21, 25, and 39 and electronically calculates the following properties of the raw stream: 1) percent BS&W, 2) composite volume weighted density (optional), 3) dry volume weighted density (optional), 4) raw stream mass flow rate (optional), and 5) raw stream volumetric flow rate (optional). Signals 101, 103, 105, 107, and 109 corresponding respectively to these results can be used to drive indicators or recorders in the unit itself, or can be transmitted to a separate indicating station or control system (not shown). The term signal is intended to encompass both analog signals in any known form (electrical, optical, pneumatic, etc.) and digitally processed transmissions.

Since the crude oil being tested is often near its flash point, a backpressure valve 47 can optionally be used to keep the pressure in the lines well above the stream vapor pressure in order to avoid flashing in any of the measuring devices.

FIG. 2 shows another embodiment designed preferably for use in a pipeline system, where the usual practice is to use smaller meter runs parallel to the pipeline, rather than processing the entire pipeline flow through the metering system. Since volumetric flow metering is carried out on the pipeline, a densitometer 51 can be used as the raw stream density meter in place of the Coriolis meter of FIG. 1. An orifice plate 49 is used to provide the differential pressure necessary to create flow through the densitometer 51. A densitometer can also be used as the clean stream density meter 53. Apparatus operation is the same as in FIG. 1, with the exception that an external volumetric flow signal 55 is sent to the BS&W calculator/controller 41 from a flow measuring sensor on the pipeline (not shown) for processing by the BS&W calculator/controller 41.

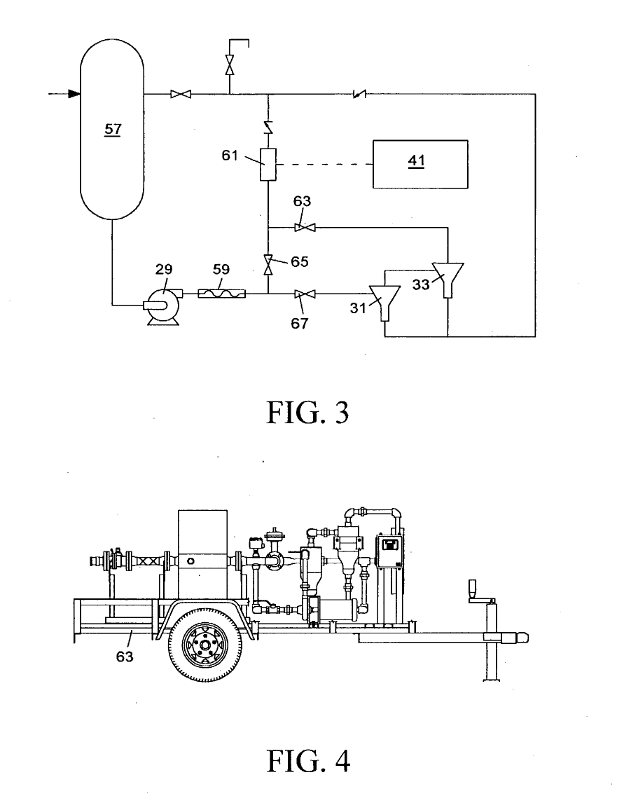

FIG. 3 shows a closed sampling system embodiment of the invention. Samples are retrieved periodically during a custody transfer period and stored in a pressurized container 57, with sample sizes being proportional to the volumetric flow measurement at the time of sampling. After custody transfer is completed, the contents of the pressurized container 57 are preferably agitated through internal spray bars or mixing tubes (not shown), but separate agitation is not necessary. Sample material is circulated by a pump 29 through a densitometer 61 after passing through an optional static mixer 59. The manual valves 63, 65, and 67 are positioned to bypass the cyclonic separators 31 and 33, and a composite density measurement is made and recorded. After a predetermined recirculation period, the valves 63, 65, and 67 are then repositioned to divert flow from the static mixer 59 through the separators 31 and 33 prior to passing through the densitometer 61. A new density measurement is taken for the ‘clean’ stream, and is processed with the previous density measurement to determine the percentage BS&W. Only signals corresponding to 101, 103, and 105 from FIGS. 1 and 2 are produced using this apparatus, since flow rates through the apparatus are not related to flow rates occurring during custody transfer.

In some cases, it is preferable to have a single apparatus capable of being moved from one location to another for testing on a number of essentially identical custody transfer lines. FIG. 4 shows a typical apparatus assembled and mounted on a trailer 63 for this purpose. Advantages include the need to calibrate and set up only one batch of equipment, and consistent propagation of measurement error. In addition, the overall equipment cost can be reduced by eliminating the need for duplicate apparatus, when simultaneous BS&W measurements from several locations are not needed.

The invention has several advantages over the prior art. The BS&W metering apparatus is more accurate than conventional devices for typical changes in flow stream temperature and composition. The apparatus can be constructed simply and relatively inexpensively, and is extremely rugged and durable. The method of the invention can be carried out automatically, with a minimum of training required for operating and maintaining the apparatus.

The invention has been shown in several embodiments. It should be apparent to those skilled in the art that the invention is not limited to these embodiments, but is capable of being varied and modified without departing from the scope of the invention as set out in the attached claims.

1. An apparatus for automatically measuring BS&W of a raw stream predominantly comprising hydrocarbon with measurable amounts of water and/or sediment, the apparatus comprising: means for measuring the density of the raw stream and producing a raw stream density signal;means for removing sediment and water from at least a portion of the raw stream, thereby producing a clean stream;means for measuring the density of the clean stream and producing a clean stream density signal; and means for processing the raw stream density signal and the clean stream density signal and producing a percent BS&W signal.

2. An apparatus as recited in claim 1, wherein the means for measuring the density of the raw stream is either a Coriolis meter or a densitometer, and the means for measuring the density of the clean stream is either a Coriolis meter or a densitometer.

3. An apparatus as recited in claim 1, wherein the means for removing sediment and water from the raw stream is at least one cyclonic separator.

4. An apparatus as recited in claim 1, wherein the means for producing a percent BS&W signal also produces a volumetric flow signal, further comprising means for measuring the temperature of the raw stream or the clean stream and producing a signal for use by the means for producing a percent BS&W signal.

5. An apparatus as recited in claim 1, further comprising a platform designed to receive and hold the means for measuring the density of the raw stream, the means for separating sediment and water out from the raw stream, the means for measuring the density of the clean stream and the means for producing a percent BS&W signal.

6. An apparatus for automatically measuring BS&W of a raw stream predominantly comprising hydrocarbon with measurable amounts of water and/or sediment, the apparatus comprising:a Coriolis meter for measuring the density of the raw stream and producing a raw stream density signal;at least one cyclonic separator for removing sediment and water from at least a portion of the raw stream, thereby producing a clean stream; a Coriolis meter or a densitometer for measuring the density of the clean stream and producing a clean stream density signal; and means for processing the raw stream density signal and the clean stream density signal and producing a percent BS&W signal.

7. An apparatus for measuring BS&W of a collection of samples of a hydrocarbon stream, comprising: a container adapted to hold the collection of samples; means for circulating the collection of samples; means for removing sediment and water from at least a portion of the circulating collection of samples, thereby producing a clean stream; means for measuring density of a stream; means for diverting the circulating collection of samples to bypass the means for removing sediment and water or to be processed by the means for removing sediment and water prior to being processed by the means for measuring density of a stream and producing a density signal; and means for processing the density signals from the means for measuring density of a stream and for producing a percent BS&W signal.

8. An apparatus as recited in claim 7, wherein the means for measuring density of a stream is either a Coriolis meter or a densitometer.

9. An apparatus as recited in claim 7, wherein the means for removing sediment and water is at least one cyclonic separator.

10. A method of automatically measuring BS&W of a raw stream predominantly comprising hydrocarbon with measurable amounts of water and/or sediment, comprising the steps of: measuring the density of the raw stream and producing a raw stream density signal; removing sediment and water from at least a portion of the raw stream, thereby producing a clean stream; measuring the density of the clean stream and producing a clean stream density signal, and processing the raw stream density signal and the clean stream density signal and producing a percentage BS&W signal.

11. The method recited in claim 10, further comprising the steps of measuring the temperature of the raw stream or the clean stream and producing a temperature signal;measuring the mass flow of the raw stream and producing a raw stream mass flow rate signal; and producing a raw stream volumetric flow rate signal.

12. A method of measuring BS&W of a collection of samples of a stream predominantly comprising hydrocarbon with measurable amounts of water and/or sediment, comprising the steps of: collecting samples of a stream at predetermined times over a predetermined period, each sample size being proportional to the flow rate of the stream at the time the sample is collected; circulating the collection of samples; measuring the density of the circulating samples and producing a raw density signal; removing sediment and water from at least a portion of the circulating samples, thereby producing a clean stream; measuring the density of the clean stream and producing a clean stream density signal; and processing the raw density signal and the clean stream density signal and producing a percentage BS&W signal.
